(19) United States
(12) Patent Application Publication
(10) Pub. No.: US 2019/0088177 A1
(43) Pub. Date: Mar. 21, 2019

(54) IMAGE PROCESSING SYSTEM AND METHOD

(71) Applicant: Acer Incorporated, New Taipei City (TW)

(72) Inventors: Chih-Wen HUANG, New Taipei City (TW); Chao-Kuang YANG, New Taipei City (TW)

(21) Appl. No.: 15/981,072

(22) Filed: May 16, 2018

(30) Foreign Application Priority Data
Sep. 20, 2017 (TW) 106132231

(51) Int. Cl. G09G 3/00; H04N 13/344; G09G 3/20

(52) U.S. Cl. CPC G09G 3/001; H04N 13/344; G09G 2370/04; G09G 2320/0252; G09G 3/2092

(57) ABSTRACT

An image processing system is provided in the invention. The image processing system includes a head-mounted display and an image processing device. The image processing device includes a processor. The processor transmits setting information of the head-mounted display to a picture driver. The picture driver obtains 3D data from a User Mode Driver and generates a left-eye picture and a right-eye picture that correspond to the head-mounted display according to the setting information and the 3D data. The processor transmits the left-eye picture and the right-eye picture to the head-mounted display and the head-mounted display displays a picture according to the left-eye picture and the right-eye picture.

### CROSS REFERENCE TO RELATED APPLICATIONS

This Application claims priority of TW Patent Application No. 106132231 filed on Sep. 20, 2017, the entirety of which is incorporated by reference herein.

### BACKGROUND OF THE INVENTION

### Field of the Invention

The invention generally relates to image processing technology, and more particularly, to image processing technology used for displaying the contents generated using the Direct3D and OpenGL graphics application programming interfaces (APIs) through a virtual reality (VR) head-mounted display.

### Description of the Related Art

With the advances being made in science and technology, the image displaying technology is progressing gradually. Virtual Reality (VR) is a display technology that uses computer science to simulate a virtual three-dimensional (3D) space. Users can wear dedicated wearable devices (e.g. a helmet, eyeglasses) to feel a realistic experience in an immersive virtual environment through their vision.

However, the contents displayed on a conventional VR helmet are being developed on a development platform which is self-developed by the developer. Thus, these conventional VR helmets are not capable of directly displaying Direct3D and OpenGL content. However, most 3D software and 3D games are being developed based on the Direct3D and OpenGL engines. Therefore, if the VR helmets are not capable of directly displaying Direct3D and OpenGL content, the content displayed by the VR helmets will be limited.

### BRIEF SUMMARY OF THE INVENTION

An image processing system and method, in which Direct3D and OpenGL content can be directly displayed by a virtual reality (VR) head-mounted display, are provided to overcome the problems mentioned above.

An embodiment of the invention provides image processing system. The image processing system comprises a head-mounted display and an image processing device. The image processing device comprises a processor. The processor transmits setting information of the head-mounted display to a picture driver. The picture driver obtains 3D data from a User Mode Driver and generates a left-eye picture and a right-eye picture that correspond to the head-mounted display according to the setting information and the 3D data. The processor transmits the left-eye picture and the right-eye picture to the head-mounted display and the head-mounted display displays a picture according to the left-eye picture and the right-eye picture.

In some embodiments, the setting information comprises pupil distance information, angle-of-vision information and field-of-view information.

In some embodiments, the 3D data is generated using the Direct3D and OpenGL technologies.

In some embodiments, the picture driver comprises a library. The picture driver loads files stored in the library, and transform the 3D data and the setting information into the left-eye picture and the right-eye picture that correspond to the head-mounted display according to the files stored in the library.

An embodiment of the invention provides an image processing method. The image processing method comprises the steps of transmitting setting information of a head-mounted display to a picture driver; obtaining 3D data from a User Mode Driver; generating a left-eye picture and a right-eye picture that correspond to the head-mounted display according to the setting information and the 3D data; transmitting the left-eye picture and the right-eye picture to the head-mounted display; and displaying a picture on the head-mounted display according to the left-eye picture and the right-eye picture.

Other aspects and features of the invention will become apparent to those with ordinary skill in the art upon review of the following descriptions of specific embodiments of image processing systems and methods.

### BRIEF DESCRIPTION OF THE DRAWINGS

The invention will become more fully understood by referring to the following detailed description with reference to the accompanying drawings, wherein:

FIG. 1 is a block diagram of an image processing system 100 according to an embodiment of the invention;

FIG. 2 is a schematic diagram illustrating architecture of the display driving operations according to an embodiment of the invention;

FIG. 3 is a schematic diagram illustrating architecture of the display driving operations according to another embodiment of the invention; and

FIG. 4 is a flow chart 400 illustrating an image processing method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

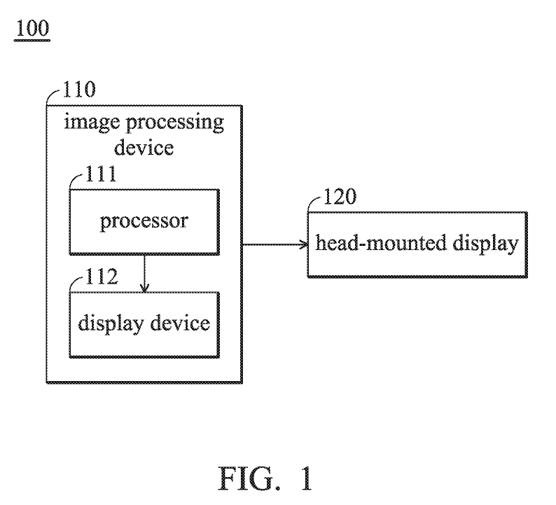

FIG. 1 is a block diagram of an image processing system 100 according to an embodiment of the invention. As shown in FIG. 1, the image processing system 100 may comprise an image processing device 110 and a head-mounted display (HMD) 120. In an embodiment of the invention the image processing device 110 may comprise a processor 111 and a display device 112. FIG. 1 presents a simplified block diagram in which only the elements relevant to the invention are shown. However, the invention should not be limited to what is shown in FIG. 1.

In the embodiments of the invention, the image processing device 110 may be a notebook, a smart phone or a tablet, but the invention should not be limited thereto. In an embodiment of the invention, the display device 112 may be a general display device, e.g. a screen of a notebook, a screen of a smart phone or a display connected to a desktop computer, but the invention should not be limited thereto. In an embodiment of the invention, the head-mounted display 120 may be a Virtual Reality (VR) helmet. When the user wants to see the VR content, the head-mounted display 120 may be coupled to the image processing device 110 to make it so the user can see the VR content through the head-mounted display 120.

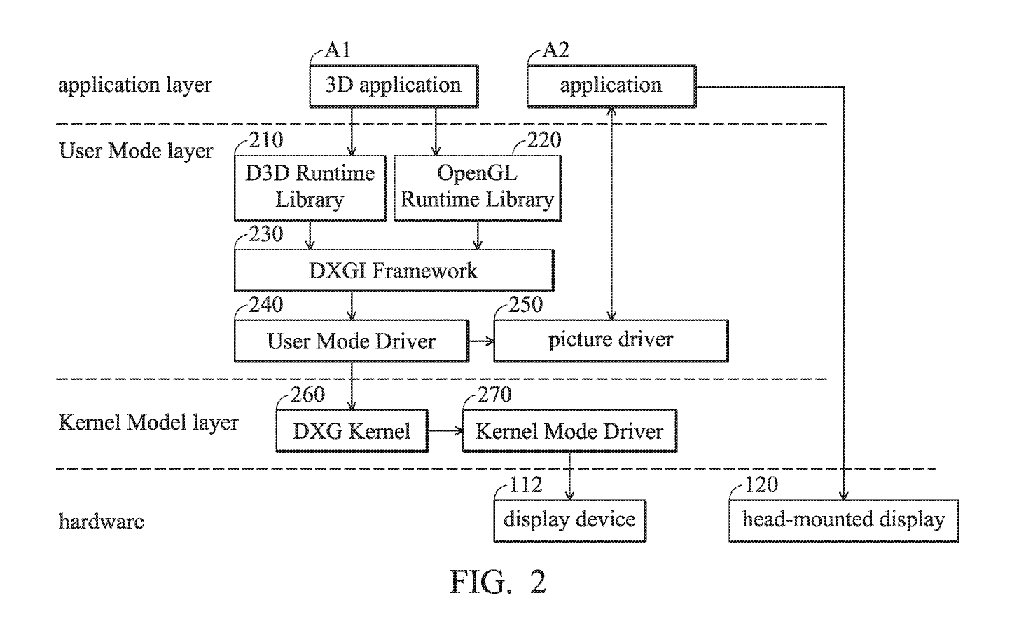

FIG. 2 is a schematic diagram illustrating architecture of the display driving operations according to an embodiment of the invention. In the embodiments of the invention, the processor 111 may perform the related display driving operations and calculations of the architecture shown in FIG. 2. As shown in FIG. 2, the architecture of the display driving operations may be divided in to an application layer, a User Mode layer and a Kernel Model layer. It should be noted that the schematic diagram of FIG. 2 is only used to conveniently illustrate the embodiments of the invention, but the invention should not be limited thereto.

According to an embodiment of the invention, the application layer may comprise the application programs, e.g. the 3D application program A1 and the application program A2 shown in FIG. 2.

According to an embodiment of the invention, the User Mode layer may comprise a Direct3D (D3D) Runtime Library 210, an OpenGL Runtime Library 220, a DirectX Graphics Infrastructure (DXGI) Framework 230, a User Mode Driver 240 and a picture driver 250. In an embodiment of the invention, the User Mode Driver 240 may comprise a User-mode display driver and an OpenGL installable client driver.

According to an embodiment of the invention, the Kernel Model layer may comprise a DirectX Kernel (DXG Kernel) 260 and a Kernel Mode Driver 270.

When the processor 111 executes a 3D application program Al (e.g. a 3D game), the processor 111 may generate 3D data using the Direct3D and OpenGL technologies. When the 3D data is displayed on a general display, the processor 111 may project the 3D images corresponding to the 3D data to the display device 112 through a conventional image display driving technology.

According to an embodiment of the invention, when the 3D data which is generated using the D3D and OpenGL technologies will be displayed on the head-mounted display 120, the processor 111 may run an application program A2 (e.g. a VR HMD display application) to generate a left-eye picture and a right-eye picture that correspond to the head-mounted display 120. Specifically, after the processor 111 has executed the application program A2, the setting information of the head-mounted display 120 may be transmitted to the picture driver 250. Furthermore, after the processor 111 has executed the 3D application program A1, the User Mode Driver 240 may provide the 3D data which is generated using the D3D and OpenGL technologies to the picture driver 250.

According to an embodiment of the invention, the 3D data may comprise the parameter settings of the 3D images which are generated using the D3D and OpenGL technologies, the position and direction of the projection camera, the information of the projection matrix, and so on. According to an embodiment of the invention, the setting information may comprise pupil distance information, angle-of-vision information and field-of-view information about the head-mounted display 120, but the invention should not be limited thereto.

According to an embodiment of the invention, after the picture driver 250 has obtained the 3D data and the setting information, the picture driver 250 may directly generate a left-eye picture and a right-eye picture that correspond to the head-mounted display 120 according to the 3D data and the setting information. After the left-eye picture and the right-eye picture that correspond to the head-mounted display 120 are generated, the picture driver 250 may transmit the left-eye picture and the right-eye picture that correspond to the head-mounted display 120 to the application layer (application program A2). Then, the application layer (application program A2) may transmit the left-eye picture and the right-eye picture that correspond to the head-mounted display 120 to the head-mounted display 120. Therefore, the user will be able to directly use the head-mounted display 120 to see the 3D pictures (or images) generated using the D3D and OpenGL technologies.

In a conventional display driving operation, the User Mode Driver 240 must obtain the bufferframe displayed on the display device 112 through the DirectX Kernel 260 and the Kernel Mode Driver 270 before the User Mode Driver 240 can transform the bufferframe displayed on the display device 112 into an appropriate format which the head-mounted display 120 can display. However, in the embodiments of the invention, the picture driver 250 can directly obtain the 3D data from the User Mode Driver 240. Therefore, the serious picture-latency generated because of too many transmissions of the instructions and signals will be decreased.

According to an embodiment of the invention, the picture driver 250 further comprises a library. When the picture driver 250 needs to generate a left-eye picture and a right-eye picture that correspond to the head-mounted display 120, the picture driver 250 may first load the files stored in the library, and then the picture driver 250 may transform the 3D data and the setting information into a left-eye picture and a right-eye picture that correspond to the head-mounted display 120 according to the files stored in the library.

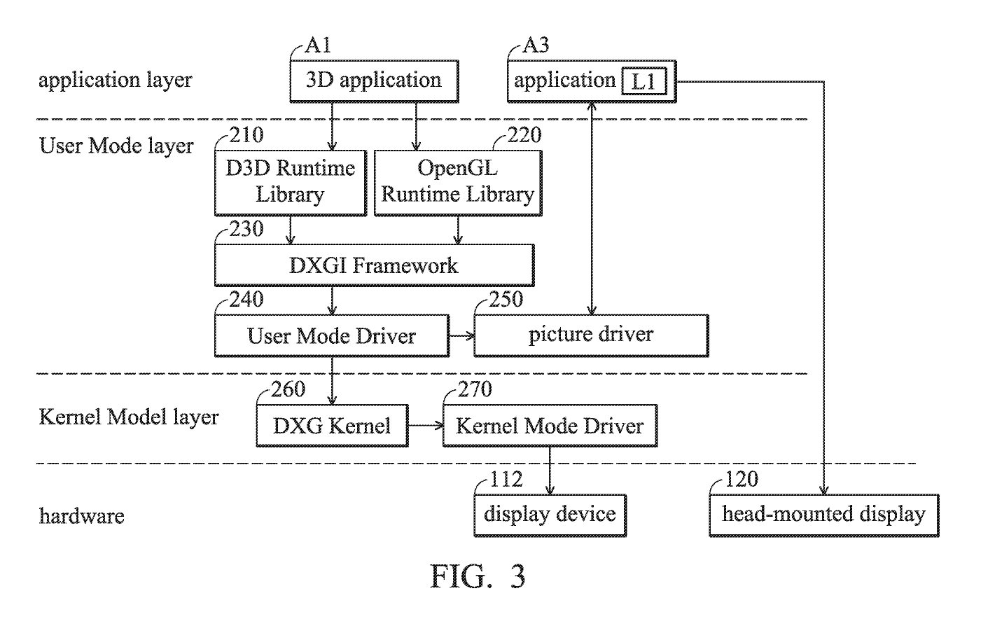

FIG. 3 is a schematic diagram illustrating architecture of the display driving operations according to another embodiment of the invention. In the embodiment of the invention, the processor 111 may perform the related display driving operations and calculations of the architecture shown in FIG. 3. It should be noted that the schematic diagram of FIG. 3 is only used for conveniently illustrating the embodiments of the invention, but the invention should not be limited thereto. In addition, the architecture shown in FIG. 3 is similar to the architecture shown in FIG. 2. Therefore, the same parts of the architectures shown in FIG. 2 and FIG. 3 are not discussed any further in the embodiment.

As shown in FIG. 3, according to an embodiment of the invention, the application program A3 may comprise a helmet library L1. The application program A3 and the helmet library L1 may be designed according to the picture displaying formats and display technologies that the head-mounted display 120 supports. When the application layer (the application program A3) obtains a left-eye picture and a right-eye picture from the picture driver 250, the helmet library L1 will be loaded and the left-eye picture and the right-eye picture from the picture driver 250 will be transformed into an appropriate format that the head-mounted display 120 supports according to the information from the helmet library L1. Then, the transformed left-eye picture and right-eye picture will be provided to the head-mounted display 120.

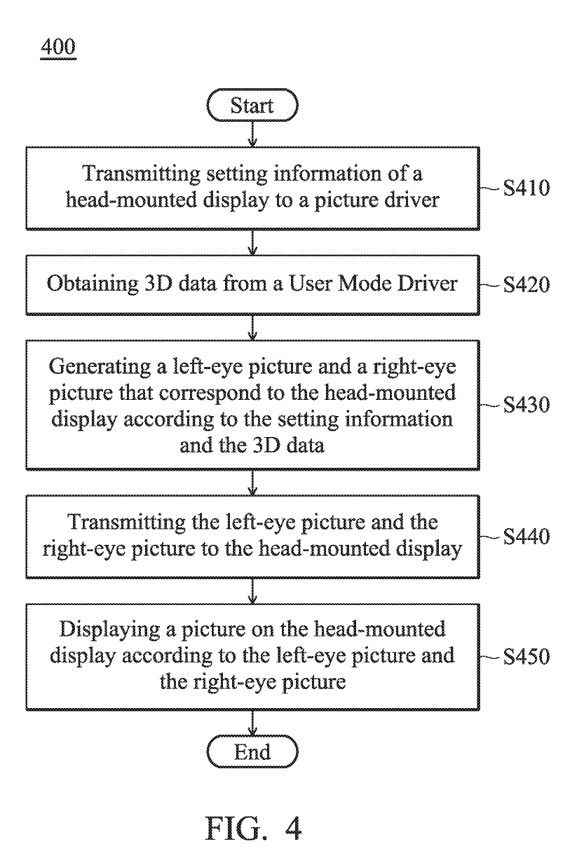

FIG. 4 is a flow chart 400 illustrating an image processing method according to an embodiment of the invention. The image processing method is applied to the image processing device 110. In step S410, setting information of a head-mounted display is transmitted to a picture driver. In step S420, 3D data is obtained from a User Mode Driver. In step S430, a left-eye picture and a right-eye picture that correspond to the head-mounted display are generated according to the setting information and the 3D data. In step S440, the left-eye picture and the right-eye picture that correspond to the head-mounted display are transmitted to the head-mounted display. In step S450, according to the left-eye picture and the right-eye picture that correspond to the head-mounted display, a picture is displayed on the head-mounted display.

According to the image processing method of the invention, the head-mounted display can directly display the 3D pictures (or images) generated using the D3D and OpenGL technologies. Therefore, the compatibility of the display contents of the head-mounted display is increased. In addition, according to the image processing method of the invention, because the head-mounted display can directly generate the left-eye picture and the right-eye picture that correspond to the head-mounted display, the user can see more real pictures through the head-mounted display. Furthermore, according to the image processing method of the invention, a picture driver is configured to directly obtain the 3D data from the User Mode Driver. Therefore, serious picture-latency caused by too many transmissions of the instructions and signals will be decreased

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. Alternatively, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

Reference throughout this specification to “one embodiment” or “an embodiment” means that a particular feature, structure, or characteristic described in connection with the embodiment is included in at least one embodiment of the invention, but do not denote that they are present in every embodiment. Thus, the appearances of the phrases “in one embodiment” or “in an embodiment” in various places throughout this specification are not necessarily referring to the same embodiment of the invention.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An image processing system, comprising:
a head-mounted display; and
an image processing device, comprising:
a processor, transmitting setting information of the head-mounted display to a picture driver,
wherein the picture driver obtains 3D data from a User Mode Driver and generate a left-eye picture and a right-eye picture that correspond to the head-mounted display according to the setting information and the 3D data, and
wherein the processor transmits the left-eye picture and the right-eye picture to the head-mounted display and the head-mounted display displays a picture according to the left-eye picture and the right-eye picture.

2. The image processing system of claim 1, wherein the setting information comprises pupil distance information, angle-of-vision information and field-of-view information.

3. The image processing system of claim 1, wherein the 3D data is generated using the Direct3D and OpenGL technologies.

4. The image processing system of claim 1, wherein the picture driver comprises a library, wherein the picture driver loads files stored in the library, and transform the 3D data and the setting information into the left-eye picture and the right-eye picture that correspond to the head-mounted display according to the files stored in the library.

5. An image processing method, comprising:
transmitting setting information of a head-mounted display to a picture driver;
obtaining 3D data from a User Mode Driver;
generating a left-eye picture and a right-eye picture that correspond to the head-mounted display according to the setting information and the 3D data;
transmitting the left-eye picture and the right-eye picture to the head-mounted display; and
displaying a picture on the head-mounted display according to the left-eye picture and the right-eye picture.

6. The image processing method of claim 5, wherein the setting information comprises pupil distance information, angle-of-vision information and field-of-view information.

7. The image processing method of claim 5, wherein the 3D data is generated using the Direct3D and OpenGL technologies.

8. The image processing method of claim 5, further comprising:
loading files stored in a library of the picture driver; and
transforming the 3D data and the setting information into the left-eye picture and the right-eye picture that correspond to the head-mounted display according to the files stored in the library.
